(19) United States
(12) Patent Application Publication
(10) Pub. No.: US 2008/0146206 A1
(43) Pub. Date: Jun. 19, 2008

(54) METHOD AND APPARATUS FOR ROUTING CONTENT BETWEEN MOBILE COMMUNICATION DEVICES

(76) Inventors: Luis A. Pichardo, Miramar, FL (US); Edward L. Gilmore, Sunrise, FL (US)

Correspondence Address: SMITH FROHWEIN TEMPEL GREENLEE BLAHA LLC, TWO RAVINIA DRIVE, SUITE 700, ATLANTA, GA, 30346, US

(21) Appl. No.: 11/610,113

(22) Filed: Dec. 13, 2006

(51) Int. Cl. H04M 3/42; H04M 1/00

(52) U.S. Cl. 455/415; 455/550.1; 455/414.1

(57) ABSTRACT

A mobile communication device (12) and method (80) for routing content between the mobile communication device and one or more other mobile communication devices, including mobile communication accessory devices, based on information within or associated with the content, such as caller identification (caller ID) information, and/or based on the available mobile communication devices connected to or associated with the mobile communication device. The method includes receiving content, such as audio content, reading caller ID information or other information associated with the content, determining which devices, including accessory devices, are connected to or associated with the mobile communication device, and routing the content directed to the mobile communication to one or more connected or associated devices based on the caller ID information and/or which devices are connected to or associated with the mobile communication device. The device includes a controller configured to route content in the described manner.

### BACKGROUND OF THE INVENTION

1. Field of the Invention

The invention relates to routing content, such as audio content, from a mobile communication device, such as a cellular telephone or other wireless handheld communication device. More particularly, the invention relates to routing content from a mobile communication device based on content information, such as audio content information, and available associated mobile communication devices.

2. Description of the Related Art

Mobile communication devices, such as cellular telephones and other handheld devices, have available a number of devices and accessories that can be attached thereto or associated therewith. For example, one accessory is a remote headset, which includes an earpiece and microphone that connect to the mobile communication device via a wired connection or wirelessly via Bluetooth or other wireless communication technology. When a user is wearing the headset, incoming calls to the mobile communication device can be routed to the headset earpiece, allowing the user to receive the incoming call privately. The user also can communicate with the calling party via the headset microphone.

Another accessory is a hands-free kit, such as a hands-free car or home/office kit. The hands-free kit can include a speakerphone and microphone that connect to the mobile communication device via a wired connection or wirelessly via Bluetooth™ or other wireless communication protocol or technology. When the mobile communication device is routing calls to the hands-free kit, the user can receive incoming calls via the speakerphone and communicate with the calling party via the microphone, which typically is conveniently positioned near the kit, e.g., in the user's car or home/office.

However, when using a hands-free kit, sometimes a user may receive a personal call or other call that the user may not want anyone else in the car or office to hear. If the incoming call is being routed from the mobile communication device to the hands-free kit, the call likely will be heard over the hands-free kit speakerphone by everyone in the immediate area. Even if a user manually switches the incoming call back over to the mobile communication device, the user still risks having others in the immediate area hearing at least the initial portion of the incoming call.

### BRIEF DESCRIPTION OF THE DRAWINGS

FIG. 1 is a block diagram of a mobile communication device system arrangement, including a mobile communication device for use in routing content based on content information;

FIG. 2 is a block diagram of a mobile communication device for use in routing content based on content information; and

FIG. 3 is a flow chart that schematically illustrates a method for routing content from a mobile communication device based on content information and available associated mobile communication devices.

### DETAILED DESCRIPTION

In the following description, like reference numerals indicate like components to enhance the understanding of the methods and devices for routing content from a mobile communication device through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The systems, devices and methods described herein involve the ability of a mobile communication device, such as a cellular telephone, to route incoming audio content and/or other content to other mobile communication devices, including mobile communication accessory devices, based on information contained within or associated with the content, such as caller identification (caller ID) information. The mobile communication device is configured to route calls (including video calls) from all or select callers to various devices connected to or associated with the mobile communication device. The mobile communication device allows the user to determine which calls from which callers or groups of callers are routed to which devices. The incoming calls are read to determine the caller, e.g., using caller ID information or other information, and the calls are routed automatically from the mobile communication device to the appropriate device based on the read call information.

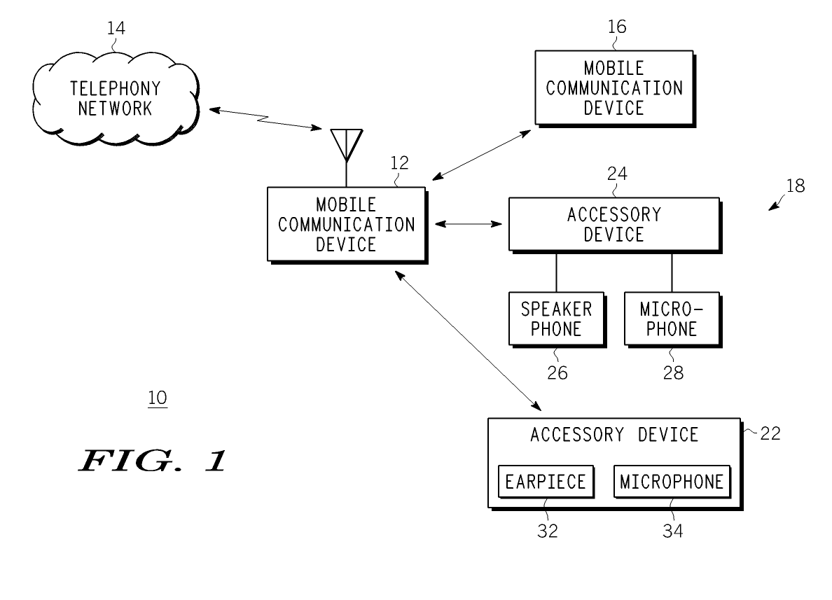

Referring now to FIG. 1, shown is a block diagram of a mobile communication device system 10 for routing content from a mobile communication device to at least one other mobile communication device, including at least one mobile communication accessory device. The system 10 includes a mobile communication device 12, which is configured to receive content, e.g., telephony signals, from a content source, such as a telephony network 14 or other suitable audio content source. It should be understood that the mobile communication device 12 can be configured to receive audio content, e.g., as part of an incoming telephone call, and/or both audio and video content, e.g., as part of a video call to the mobile communication device 12. The telephony network 14 can be any suitable wireless or wired telephony network, such as a cellular digital packet data (CDPD) network, a global system for mobile (GSM) communication network, a time division multiple access (TDMA) network, a code division multiple access (CDMA) network, a voice over Internet Protocol (VoIP) network, a personal digital cellular (PDC) network, a personal handy-phone system (PHS) network or other suitable network.

As will be discussed in greater detail hereinbelow, the mobile communication device 12 is configured to route content, e.g., incoming calls from the network 14, to one or more other mobile communication devices 16 and/or one or more mobile communication accessory devices, e.g., a hands-free car or home/office kit 18 and/or a headset accessory device 22. Also, as will be discussed in greater detail hereinbelow, routing the content from the mobile communication device 12 is based on information included as part of and/or associated with the content, such as caller identification (caller ID) information, and/or based on which devices are available to have content routed thereto.

The mobile communication device 12 can be any suitable device or devices suitable for use in a telephony system, such as any telephony device that communicates with the telephony network 14. For example, the mobile communication device 12 can be a mobile or cellular telephone, a smartphone, a personal digital assistant (PDA) or other wireless handheld device with telephony capability, a digital camera with wireless telephony capability, a laptop personal computer (PC) or a notebook PC. Although the mobile communication device 12 is discussed herein primarily as a mobile device, it should be understood that the mobile communication device 12 can be a video processing device, such as a video decoder (set-top) box, with built-in or connected telephony capability. Also, it should be understood that the mobile communication device 16 can be any such suitable telephony device.

The hands-free car or home/office kit 18 is any suitable mobile communication accessory device that links a cellular telephone or other mobile communication device 12 with an automobile or home/office location in a manner that allows a user hands-free communication with the mobile communication device 12. The hands-free kit 18 typically includes a base unit 24, typically mounted somewhere in the car, e.g., under the dashboard or under the passenger seat, or located somewhere in the home/office. The hands-free kit 18 also includes a microphone 26, connected to the base unit 24, that is pointed toward the driver or user, and a speakerphone 28, connected to the base unit 24, that is positioned in a suitable location within the car or home/office to be heard by the driver/user.

The mobile communication device 12 is connected to the hands-free kit 18 via the base unit 24, e.g., by a wired connection or wirelessly via Bluetooth or other suitable wireless communication network technology. Bluetooth refers to an industry standard for short range wireless connectivity and data transfer within personal area networks (PANs), also referred to as piconets. The Bluetooth standard, which also is known by the IEEE standard 802.15.1, allows communication devices, including mobile communication devices, to connect, communicate and exchange information wirelessly in a relatively secure and inexpensive manner using short range radio frequency (RF). It should be understood that other wireless communication protocols and technologies can be used to connect or associate the mobile communication device 12 with the hands-free kit 18.

As an example, the mobile communication device can be placed in a cradle (not shown) that connects to the base unit 24 and provides charging and an antenna connection to the mobile communication device 12. For the Bluetooth version, a control panel (not shown), either connected to or part of the base unit 24, can provide the necessary wireless networking and operational control between the mobile communication device 12 and the base unit 24.

In operation, in general, calls involving the mobile communication device 12 are routed to the hands-free kit 18 in a manner that allows the user to listen to the caller through the speakerphone 26 and speak to the caller through the microphone 28. Depending on the type of hands-free kit 18, volume control and the ability to initiate and end calls can be performed via the mobile communication device 12 itself or through controls connected to or part of the base unit 24.

The headset accessory device 22 can be any suitable device that can transfer communication between the mobile communication device 12 and its user to the headset accessory device 22. The headset accessory device 22 typically includes an earpiece 32 and a microphone 34 that connect to the mobile communication device 12, e.g., via a wired connection or wirelessly via Bluetooth or other wireless technology. The headset accessory device 22 can include a base unit, although such is not necessary. Such base unit could include digital processing elements that convert signals between analog and digital form, thus allowing the connection between the headset accessory device 22 and the mobile communication device 12 to be digital. In operation, the headset accessory device 22 routes incoming communications to the mobile communication device 12 through to the earpiece 32. Outgoing communications from the user to the microphone 34 are routed from the headset accessory device 22 to the mobile communication device 12.

It should be understood that, although the mobile communication accessory devices discussed hereinabove include a hands-free car or home/office kit accessory device 18 and a headset accessory device 22, other mobile communication devices and mobile communication accessory devices are suitable for use in connecting to and/or associating with the mobile communication device 12 and receiving content routed from the mobile communication device 12. Also, although the systems, methods and devices discussed herein are described primarily with respect to mobile communication devices routing audio content based on audio content information, such as caller ID information, it should be understood that the systems, methods and devices discussed herein are suitable for use with video calls as well, including routing video content and/or audio content based on video call content information. Moreover, it should be understood that the devices discussed herein do not have to be mobile devices, e.g., video processing devices, such as video decoder (set-top) boxes with telephony capability, are suitable for use in the systems and methods described herein.

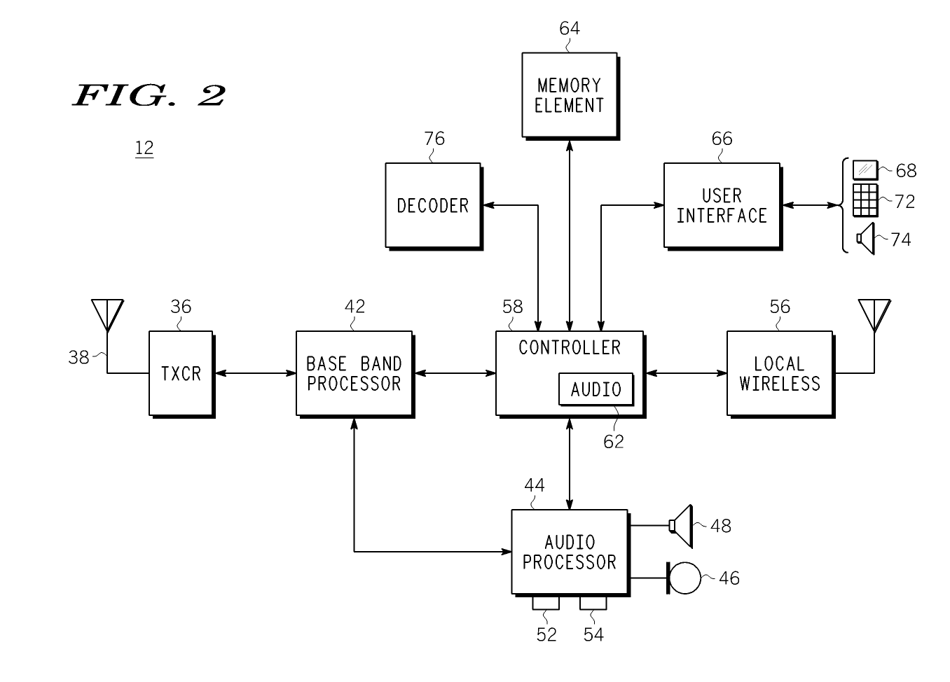

Referring now to FIG. 2, with continuing reference to FIG. 1, shown is a block diagram of a mobile communication device for use in routing audio content based on audio content information, e.g., the mobile communication device 12 in FIG. 1. As discussed hereinabove, the mobile communication device 12 can be a mobile or cellular telephone, a smartphone, a personal digital assistant (PDA) or other wireless communication device.

The mobile communication device 12 typically includes a mobile communications transceiver 36, which modulates and demodulates, filters, and amplifies signals sent and received over an antenna 38, according to suitable air interface communication protocols. The transceiver 36 is coupled to a baseband processor 42, which digitally processes information to be transmitted by, or that has been received from, the transceiver 36. For example, the baseband processor 42 encodes voice signals and applies forward error correction, digital filtering and other digital processing.

The mobile communication device 12 also typically includes an audio processor 42 coupled to the baseband processor 42. The audio processor 44 converts analog signals of an acoustic origin to digital signals, and vice versa. For example, when a user of the mobile communication device 12 speaks, a microphone 46 coupled to the audio processor 44 converts the acoustic signal to an analog electrical signal, which is processed and digitized by the audio processor 44 to produce a digital signal, which is fed to the baseband processor 42. Similarly, the baseband processor 42 receives demodulated signals from the transceiver 36, and processes the demodulated signals to provide digital audio signals to the audio processor 44. The audio processor 44, in turn, converts the digital audio signals to analog signals, which are played over a speaker 48 that is coupled to the audio processor 44.

The audio processor 44 can support additional audio devices, such as accessory devices like the hands-free kit accessory device 18 and/or the headset accessory device 22 shown in FIG. 1 and described hereinabove. For example, the audio processor can have one or more coupling ports or interfaces 52, 54 for connecting additional audio devices, such as accessory devices, to the mobile communication device 12. It should be understood that the interfaces 52, 54 can be a single interface configured to connect to multiple audio devices, including accessory devices. Also, it should be understood that additional audio devices can be connected to the audio processor 44 via an extended mode universal (EMU) serial bus (not shown) or other suitable connection components.

Alternatively, as discussed hereinabove, accessory devices and other audio devices can be associated with the mobile communication device 12 via a suitable wireless networking technology, such as Bluetooth. The mobile communication device 12 can include a local wireless transceiver 56, which can be used to link with any suitable mobile communication devices over a low power radio frequency link. For example, the local wireless transceiver 56 can be used to provide a local wireless link between the mobile communication device 12 and one or more of the mobile communication device 16, the hands-free kit accessory device 18 and/or the headset accessory device 22 shown in FIG. 1 and described hereinabove.

The baseband processor 42, the audio processor 44 and the local wireless transceiver 56 are coupled to a controller or application processor 58, which is the central processor of the mobile communication device 12, and is coupled to all major subsystems of the mobile communication device 12. The controller 58 executes an audio application 62 for performing audio content routing, as will be discussed in greater detail hereinbelow. The audio application 62 can be implemented in software, e.g., using operating system elements instantiated in the software architecture of the mobile communication device 12.

The mobile communication device 12 also typically includes a memory element or storage device 64 coupled to the controller 58. The memory element 64 can store application programs and data structures used by application programs, as well as other information. The memory element 64 can be any suitable information storage unit, such as any suitable magnetic storage or optical storage device, including magnetic disk drives, magnetic disks, optical drives, optical disks, and memory devices, including random access memory (RAM) devices, and flash memory. Although represented here abstracted as a single block, the memory element 64 can include multiple memory elements, including a variety of memory types, such as those provided hereinabove. Also, although the memory element 64 is shown as an internal part of the mobile communication device 12, the memory element 64 can be located external to the mobile communication device 12 and suitably coupled thereto.

The controller 58 also operates a user interface 66 coupled thereto, which also is abstracted here as a single block. It should be understood that the user interface 66 involves a variety of hardware and software elements for allowing a user of the mobile communication device 12 to interact with the mobile communication device 12, including inputting information and commands, and receiving information. The user interface 66 includes various interface elements, such as a graphical display 68, a keypad and buttons 72, and an audio transducer 74 for producing audible alerts, such as ringing when a call is attempting to be made to the mobile communication device 12.

The mobile communication device 12 also includes a decoder 76 coupled to and/or contained within the controller 58. As will be discussed in greater detail hereinbelow, the decoder 76 is configured to decode and/or identify various information from among the telephony signals received by the mobile communication device 12 and to provide such information to the controller 58 for further processing. For example, the decoder is configured to decode and/or identify caller identification (or caller ID) information, if included, from among the telephony signals received by the mobile communication device 12.

Caller identification, or caller ID, is a telephony service or feature that transmits a caller's name and/or telephone number to the called party's telephony device as the call is being made but before the called party answers the call. The caller ID feature usually allows the called party to identify the calling party, via the graphical display 68 or other portion of the mobile communication device 12, without having to answer the call. Caller ID information often is part of an audio signal that is transmitted in the same audio band and in the same manner as conventional voice data.

One or more of the transceiver 36, the baseband processor 42, the audio processor 44, the local wireless transceiver 56, the controller 58, the memory element 64, the user interface 66, the decoder 76 and any other components in the mobile communication device 12 can be comprised partially or completely of any suitable structure or arrangement, e.g., one or more integrated circuits. Also, it should be understood that the mobile communication device 12 includes other components, hardware and software (not shown) that are used for the operation of other features and functions of the mobile communication device 12 not specifically described herein.

The mobile communication device 12 can be partially or completely configured in the form of hardware circuitry and/or other hardware components within a larger device or group of components. Alternatively, the mobile communication device 12 can be partially or completely configured in the form of software, e.g., as processing instructions and/or one or more sets of logic or computer code. In such configuration, the logic or processing instructions typically are stored in a data storage device, e.g., the memory element 64 or other suitable data storage device (not shown). The data storage device typically is coupled to a processor or controller, e.g., the controller 58 or other suitable processor or controller (not shown). The processor accesses the necessary instructions from the data storage device and executes the instructions or transfers the instructions to the appropriate location within the mobile communication device 12.

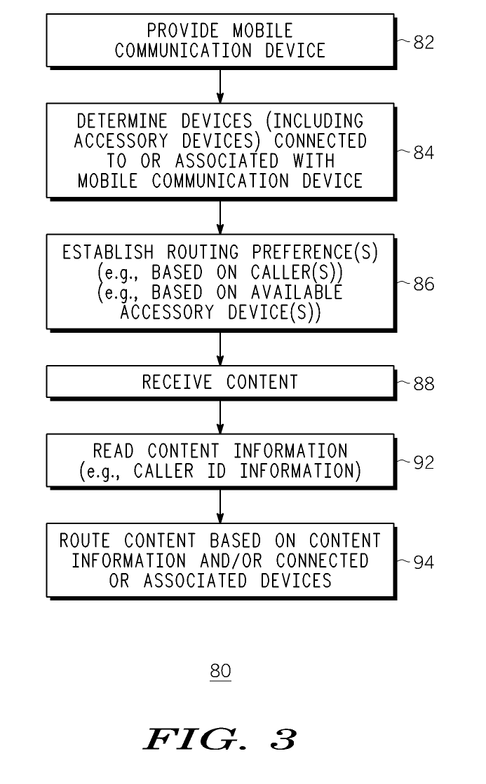

Referring now to FIG. 3, with continuing reference to FIG. 1 and FIG. 2, shown is a flow chart that schematically illustrates a method 80 for routing audio content from a mobile communication device based on audio content information and/or available associated mobile communication devices, including mobile communication accessory devices. The method 80 includes a step 82 of providing a mobile communication device, such as the mobile communication device 12 shown in FIG. 1 and FIG. 2.

The method 80 also includes a step 84 of determining or detecting whether any devices, including any mobile communication accessory devices, are connected to and/or associated with the mobile communication device 12. For example, the mobile communication device 12, via its controller 58 and/or other appropriate components, is configured to determine if one or more devices, including accessory devices, are connected directly to the mobile communication device 12, e.g., via a wired connection. The mobile communication device 12 also can determine if one or more devices are associated with the mobile communication device 12, e.g., wirelessly via Bluetooth or other wireless communication technology. As will be discussed in greater detail hereinbelow, the particular devices that are connected to and/or associated with the mobile communication device 12 can affect the manner in which audio content is routed from the mobile communication device 12 to one or more of the connected or associated devices.

The method 80 can include a step 86 of establishing preferences for routing at least a portion of the audio content received by the mobile communication device 12. In general, the user of the mobile communication device 12 can select to establish which incoming calls from which callers are routed to which devices connected to and/or associated with the mobile communication device 12. The mobile communication device 12 can establish routing preferences based on the source of the audio content, e.g., the calling party placing the incoming call to the mobile communication device 12. Alternatively, the mobile communication device 12 can establish routing preferences based on the one or more devices, including mobile communication accessory devices, connected to and/or associated with the mobile communication device 12. The user can set up the mobile communication device 12 to perform in this manner, e.g., via a settings configuration menu provided by the controller 58 and accessible to the user via the user interface 66.

For example, according to the step 86, a user of the mobile communication device 12 can set up or establish that all incoming calls to the mobile communication device 12 from a particular caller or group of callers be routed from the mobile communication device 12 to a particular mobile communication accessory device connected to the mobile communication device 12, if that particular accessory device is connected to the mobile communication device 12. The callers can be determined by their respective caller ID information or other suitable information. Therefore, in this manner, incoming calls to the mobile communication device 12 are routed based on caller ID information.

Alternatively, for example, according to the step 86, a user of the mobile communication device 12 can set up or establish that when a particular mobile communication accessory device, e.g., the hands-free kit accessory device 18, is connected to the mobile communication device 12, all incoming calls to the mobile communication device 12 will be routed to that device. A possible variation on this setup is that, instead of all incoming calls being routed to the accessory device, calls are routed based on their caller ID information. As discussed, the mobile communication device 12 can be set up to determine which caller IDs initiate routing and which caller IDs do not imitate routing. It should be understood that, according to the step 86, the mobile communication device 12 can set up or establish a plurality of routing preferences, including simultaneous routing preferences, including those in which one or more routing preferences have priority over one or more other routing preferences.

The method 80 also includes a step of the mobile communication device 12 receiving audio content. As discussed hereinabove, the mobile communication device 12 is configured to receive audio content, such as wireless telephony signals, from a suitable content source, such as the wireless telephony network 14, via the transceiver 36. The received audio content is provided to the appropriate components within the mobile communication device 12, e.g., the controller 58, for various processing, e.g., as described hereinabove.

The method 80 also includes a step 92 of reading audio content information, such as caller ID information. As discussed hereinabove, the mobile communication device 12 includes a decoder 76 and/or other suitable components that are configured to read various audio content information from among the telephony signals received by the mobile communication device 12. Such audio content information can include caller ID information and other information that is part of or associated with an incoming call to the mobile communication device 12. Caller ID information allows the mobile communication device 12 to determine or otherwise identify the calling party, via the graphical display 68 or other portion or the mobile communication device 12, without the user of the mobile communication device 12 having to answer the call. According to the reading step 92, the audio content information is read and provided to the controller 58 or other appropriate component or components of the mobile communication device 12 for further processing.

The method 80 includes a step 94 of routing audio content based on the audio content information read by the reading step 92 and/or the devices connected to or associated with the mobile communication device 12, e.g., as determined by the determining step 84. For example, according to the step 94, the mobile communication device 12 can route an incoming call received by the mobile communication device 12 based on the caller ID information associated with the incoming call. As discussed hereinabove, based on caller ID information and/or other information associated with incoming or received audio content, calling preferences can be established to dictate which audio content is routed to which devices. Also, according to the routing step 94, audio content can be routed to one or more devices, including one or more mobile communication accessory devices, depending on which device or devices actually are connected to or associated with the mobile communication device 12.

It should be understood that at least part of the routing step 94 can include the option of not routing the incoming audio content anywhere, but rather answering or taking the incoming call via the mobile communication device 12. For example, a user can establish that calls received from one or more particular calling parties are not to be routed from the mobile communication device 12. Alternatively, a user can establish that when certain accessory devices are connected to (or not connected to) the mobile communication device 12, calls and/or other audio content received by the mobile communication device 12 are not to be routed from the mobile communication device 12. For example, according to the routing step 94, calls from any of the user's immediate family members are not to be routed to an accessory device, but rather are to be received directly by the mobile communication device 12.

Also, it should be understood that at least part of the routing step 94 applies to outgoing audio content from the mobile communication device 12 to various called parties. Such arrangement can be automatic, e.g., depending on the routing of the incoming audio content that is part of the same call, or may occur automatically based on the device to which the incoming audio content is routed. For example, if incoming audio content to the mobile communication device 12 is to be routed to a particular device connected to the mobile communication device 12, outgoing audio content to the calling party likely will occur via the same connected device. However, such is not necessary.

It should be understood that, although many of the devices and methods discussed herein are shown and described as Bluetooth devices and Bluetooth-enabled devices, the devices and methods herein discussed are suitable for use with any suitable near range or wireless personal area network (WPAN), any local area network (LAN) and/or wide area network (WAN) technology or technologies, including wireless local are network (WLAN) technologies. Such WPAN technologies include but are not limited to ZigBee, Ultra Wideband, Wireless USB, Z-wave, the Infrared Data Association (IrDA), nanoNET, any suitable technologies and enabled devices in accordance with the Wi-Fi standards, and any suitable technologies and enabled devices in accordance with the 802.11 family of standards. Also, the devices and methods herein discussed are suitable for use in accordance with the integrated Digital Enhanced Network (iDEN) wireless telephony protocols, including the Wideband integrated Digital Enhanced Network (WiDEN) software upgrades.

The method shown in FIG. 3 may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the methods and device for routing content from a mobile communication device herein described without departing from the spirit and scope of the invention as defined by the appended claims and their full scope of equivalents.

1. A method for routing content, comprising the steps of:
receiving content directed to a first communication device, wherein the content can include caller ID information;
reading the caller ID information;
determining if the first mobile communication device has associated therewith at least one second mobile communication device;
routing at least a portion of the content to one of the first mobile communication device or one of the at least one second mobile communication devices based on the caller ID information.

2. The method as recited in claim 1, wherein the routing step includes routing the content to one of the first mobile communication device or one of the at least one second mobile communication devices based on the available second mobile communication devices associated with the first mobile communication device.

3. The method as recited in claim 1, wherein the content can include a first set of caller ID information associated with a first caller and a second set of caller ID information associated with a second caller, and wherein the routing step routes the content to the first mobile communication device in response to the content including caller ID information from the first set of caller ID information and routing step routes the content to the second mobile communication device in response to the content including caller ID information from the second set of caller ID information.

4. The method as recited in claim 1, further comprising the step of configuring the first communication device to route received content based on the caller ID information.

5. The method as recited in claim 1, further comprising the step of configuring the first communication device to route received content based on the available second mobile communication devices associated with the first mobile communication device.

6. The method as recited in claim 1, wherein the content is a video call including audio content and video content, and wherein the routing step routes at least a portion of at least one of the audio content and the video content based on the caller ID information.

7. The method as recited in claim 1, wherein the at least one second mobile communication device is a mobile communication device accessory device.

8. The method as recited in claim 7, wherein at least one of the second mobile communication devices is a mobile communication device selected from the group consisting of a hands-free car kit, a hands-free home/office kit, a wired headset and a wireless headset.

9. The method as recited in claim 1, wherein the at least one second mobile communication device is associated with the first mobile communication device over a local wireless link.

10. The method as recited in claim 1, wherein the at least one second mobile communication device is associated with the first mobile communication device via a wired connection.

11. The method as recited in claim 1, wherein the first mobile communication device is a mobile communication device selected from the group consisting of a cellular telephone, a smartphone, a personal digital assistant (PDA), a wireless handheld device, a digital camera, a laptop personal computer (PC), a notebook PC, a video processing device, a video decoder device and a set-top box.

12. A mobile communication device, comprising:
a transceiver configured to receive content, wherein the content can include caller ID information; and
a controller coupled to the transceiver for processing content,
wherein the controller is configured to read caller ID information from among the content received by the mobile communication device,
wherein the controller is configured to determine if the mobile communication device has associated therewith at least one other/second mobile communication device, and
wherein the controller is configured to route at least a portion of the content to the at least one other/second mobile communication device associated with the mobile communication device based on the caller ID information.

13. The device as recited in claim 12, wherein the at least one other mobile communication device is a device selected from the group consisting of a hands-free kit accessory device, a wireless headset accessory device, a cellular telephone, a smartphone, a personal digital assistant (PDA), a wireless handheld device, a digital camera, a laptop personal computer (PC), a notebook PC, a video processing device, a video decoder device and a set-top box.

14. The device as recited in claim 12, wherein the mobile communication device is a device selected from the group consisting of a cellular telephone, a smartphone, a personal digital assistant (PDA), a wireless handheld device, a digital camera, a laptop personal computer (PC), a notebook PC, a video processing device, a video decoder device and a set-top box.

15. The device as recited in claim 12, wherein the at least one other mobile communication device is associated with the mobile communication device over a local wireless link.

16. The device as recited in claim 12, wherein the content is a video call including audio content and video content, and wherein the controller is configured to route at least a portion of at least one of the audio content and the video content based on the caller ID information.

17. The device as recited in claim 12, wherein the controller is configured to route audio content from the mobile communication device to the at least one other mobile communication device via at least one of a wired connection and wirelessly.

18. The device as recited in claim 12, wherein at least a portion of the mobile communication device is implemented in hardware.

19. The device as recited in claim 12, wherein at least a portion of the mobile communication device is implemented in software executed by a computer.
